(19) United States
(12) Patent Application Publication
(10) Pub. No.: US 2021/0174246 A1
(43) Pub. Date: Jun. 10, 2021

(54) Adaptive learning system utilizing reinforcement learning to tune hyperparameters in machine learning techniques

(71) Applicant: Ciena Corporation, Hanover, MD (US)

(72) Inventor: Thomas Triplet, Manotick (CA)

(21) Appl. No.: 16/707,694

(22) Filed: Dec. 9, 2019

(51) Int. Cl. G06N 20/00

(52) U.S. Cl. CPC G06N 20/00

(57) ABSTRACT

Systems and methods are provided in the field of Artificial Intelligence (AI) for enhancing, improving, augmenting, or tuning hyperparameters of Machine Learning (ML) techniques for creating a ML model. According to one implementation, a ML method comprises a step of using Reinforcement Learning (RL) to tune hyperparameters of one or more ML techniques. The method also includes the step of training a ML model using the one or more ML techniques in which the respective hyperparameters were tuned in the RL.

### TECHNICAL FIELD

The present disclosure generally relates to Artificial Intelligence (AI). More particularly, the present disclosure relates to meta-learning and automatic Machine Learning (ML) using Reinforcement Learning (RL) strategies to tune hyperparameters of ML techniques for training ML models.

### BACKGROUND

FIG. 1 is a chart showing a number of configurations of known neural networks that may be used for creating Machine Learning (ML) models. The chart is based on a compilation created by Fj odor van Veen of the Asimov Institute. Each of the neural networks shown in FIG. 1 includes a plurality of cells (or neurons). Each cell can be configured as input cells, output cells, hidden cells, just to name a few. The cells can be combined in other number of ways to define new, more sophisticated neural network topologies, which in turn may have better accuracy. Some of the neural networks of FIG. 1 are deep neural networks having multiple intermediate (e.g., hidden) layers.

FIG. 2 is a diagram illustrating features of a cell (or neural), which may represent one or more types of cells shown in the neural networks of FIG. 1. As shown, the cell 10 includes a plurality of inputs 12 for receiving data. The inputs 12 are weighted by weights 14, and the weighted inputs are applied to a transfer function (Σ) 16. The cell 10 also includes an activation function (φ) 18 that combines a net input from the transfer function 16 and a threshold (θ) to provide an activation signal. For example, the activation function 18 may be configured to apply a sigmoid function, a tangential (tan h) function, a Rectified Linear Unit (ReLU) function, a leaky ReLU function, a max-out function, an Exponential Linear Unit (ELU), and/or other suitable types of adaptive functions. The cell 10 in this example comprises a number of intrinsic hyperparameters, whereby some of the hyperparameters include values that may be used by the transfer function Σ, the activation function φ, and a threshold θ. The cell 10 also includes weights 14, which may be learned during the training and depend on the input data 12.

Accuracy improvements come at the cost of significant complexification of the underlying neural network topologies which rely on an increasing number of hidden layers, leading to hundreds of hyperparameters to define, before the neural network can be trained. For instance, a Residual Neural Network (ResNet) was developed in 2015 that was the first ResNet to be able to match human-level accuracy for classifying images. However, this ResNet is extremely complex, having 152 layers of neurons.

FIGS. 3a and 3b illustrate dialog boxes that may be used for entering hyperparameters for two known ML techniques. For example, FIG. 3a shows a dialog box 22 for entry of hyperparameters for a Random Forest ML technique. FIG. 3b shows a dialog box 26 for entry of hyperparameters for a Support Vector Machine (SVM) ML technique.

Improvements in ML have recently been driven by improvements to multi-layer neural networks (also known as deep learning). The topology of the neural network (i.e., how individual neurons are combined, such as the examples shown in FIG. 1), as well as the transfer function 16 and activation function of each neuron 10 (as shown in FIG. 2) are all defined by hyperparameters of the neural network. Neural networks are considered to be Turing-complete since any problem solvable by a computer can be solved by a neural network with adequate topology and training. However, their hyperparameter space is infinite, which creates issues with respect to the process of optimizing hyperparameters.

Various neural networks (such as those shown in FIG. 1) may typically rely on systematically stepping through the hyperparameter space in a discrete manner. That is, a human expert typically discretizes each hyperparameter manually using some value entry device, such as the dialog boxes shown in FIGS. 3a and 3b for entering parameter values for the Random Forest technique (FIG. 3a) and the SVM technique (FIG. 3b). Also, the human expert may specify a range of acceptable discrete values, and the neural network may then automate the process of systematically trying all combinations of all possible values of the hyperparameters using a brute-force approach. Variants of this systematic grid-search approach include random search (i.e., trying random values of hyperparameters until accuracy is good enough), greedy search (i.e., local optimal tuning of the hyperparameters), and Bayesian optimization.

There are various shortcomings of the conventional deep neural networks. Systematic search of optimal hyperparameters works well for simpler ML techniques such as Random Forest or SVM whose training time is small and whose hyperparameter space has low dimensionality. However, the approach becomes impractical with more complex techniques such as deep neural networks required to achieve state-of-the-art accuracy. For instance, training a single deep neural with tens or hundreds of layers can take hours or days on very expensive clusters of specialized hardware (e.g. Graphics Processing Units (GPUs), Tensor Processing Units (TPUs), neural chips, etc.). Compounding the issue, more complex models such as neural networks typically have hundreds or thousands of hyperparameters that may need to be tuned in an attempt to achieve optimized values.

The complexification of multi-layered neural networks over time may lead to improved accuracy. To test the results of various neural networks, techniques are currently evaluated in the ImageNet Large Scale Visual Recognition Challenge (ILSVRC) to determine the best performing techniques for object detection and image classification at large scale. In 2012, a convolutional neural network (CNN) called AlexNet found success by utilizing Graphics Processing Units (GPUs) during training. In 2015, the ResNet technique, as described above, used a very deep CNN with 152 layers to outperform the 2012-winner AlexNet.

Along with the increased number of layers, various design/topology patterns were empirically discovered where each pattern could perform a specific task. For instance, Recurrent Neural Networks (RNNs) and the Long/Short Term Memory (LSTM) variant are effective to analyze and forecast sequences and time series such as performance metrics, while CNNs are best to identify patterns in images and Generative Adversarial Networks (GANs) are best to build simulators.

One issue to consider with any type of ML model is the computation time (i.e., training time) that is required to create a ML model, particularly when the complexity of neural networks continues to increase. The training times for three popular techniques on the same small dataset (including about 18,000 samples) were measured. The training time for Random Forest with about 18,000 samples was 2,090 ms and the training time for SVM was 200 ms. However, for a neural network with only five layers was found to be 37,000 ms.

Although these training times may be acceptable in many situations, the time required to tune hyperparameters of these three ML techniques demonstrates that the complexity of the technique effects the hyperparameter tuning/optimizing time exponentially. For example, even when the techniques were conservatively evaluated under the condition that they merely optimize three hyperparameters and each hyperparameter can include only 15 different values, the techniques required an unacceptably long time. The Random Forest technique required about two hours to optimize the three hyperparameters; the SVM technique required about 11 minutes to optimize the three hyperparameters; and the neural network with five layers (which, by definition, would include at least five hyperparameters) required about 35 hours to optimize the three hyperparameters. Therefore, as complexity increases, the usefulness of these complex techniques with respect to optimizing hyperparameters decreases because of the excessively long time required to complete this task.

Scanning the hyperparameter space can be trivially distributed on a cluster to reduce computation time linearly with the number of machines. However, given that the complexity of the systematic search approach grows exponentially with the number of parameters, the linear horizontal scalability of the method does not help. Similar to systematic hyperparameter space search, the Bayesian optimization approach is efficient when the number of hyperparameters is low (typically <20), but performs poorly otherwise which makes the approach applicable only to simpler techniques but useless to optimize the topology of deep neural networks.

Therefore, there is a need in the field of machine learning to provide a more reliable process for tuning hyperparameters for training a ML model, while also being able to perform the hyperparameter tuning process within a reasonable amount of time.

### BRIEF SUMMARY

The present disclosure describes Machine Learning (ML) systems and methods. According to one embodiment, a ML system comprises a processing device and a memory device configured to store a retrospect learning module. The retrospect learning module includes logic instructions configured to cause the processing device to use Reinforcement Learning (RL) to tune hyperparameters of one or more ML techniques and to cause the processing device to train a ML model using the one or more ML techniques in which the respective hyperparameters were tuned in the RL.

According to another embodiment, a method comprises the steps of using RL to tune hyperparameters of one or more ML techniques and training a ML model using the one or more ML techniques in which the respective hyperparameters were tuned in the RL.

According to yet another embodiment, a non-transitory computer-readable medium is configured to store computer logic having instructions that, when executed, cause one or more processing devices to use RL to tune hyperparameters of one or more ML techniques. The instructions further cause the one or more processing devise to train a ML model using the one or more ML techniques in which the respective hyperparameters were tuned in the RL.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a chart showing a number of known neural networks having different configurations of cells;

FIG. 2 is a diagram showing a conventional cell that may be used in one of the neural networks of FIG. 1;

FIGS. 3a and 3b are diagrams showing dialog boxes for allowing a human expert to manually enter hyperparameters for conventional Machine Learning (ML) techniques;

FIG. 4 is a block diagram illustrating an adaptive machine learning system, according to various embodiments of the present disclosure;

FIG. 5 is a block diagram illustrating features of the retrospect learning module shown in FIG. 4, according to various embodiments of the present disclosure;

FIG. 6 is a block diagram illustrating the retrospect learning module of FIG. 4 utilized within a Reinforcement Learning (RL) system, according to various embodiments of the present disclosure;

FIG. 7 is a diagram illustrating state, action, and reward components of the RL system when applied to the adaptive machine learning system of FIG. 4, according to various embodiments of the present disclosure;

FIG. 8 is a flow diagram illustrating a method for training a ML model within the RL system, according to various embodiments of the present disclosure;

FIG. 9 is a flow diagram illustrating another method for training a ML model, according to various embodiments of the present disclosure; and

FIG. 10 is a flow diagram illustrating a method for calculating a forgetting score, according to various embodiments of the present disclosure.

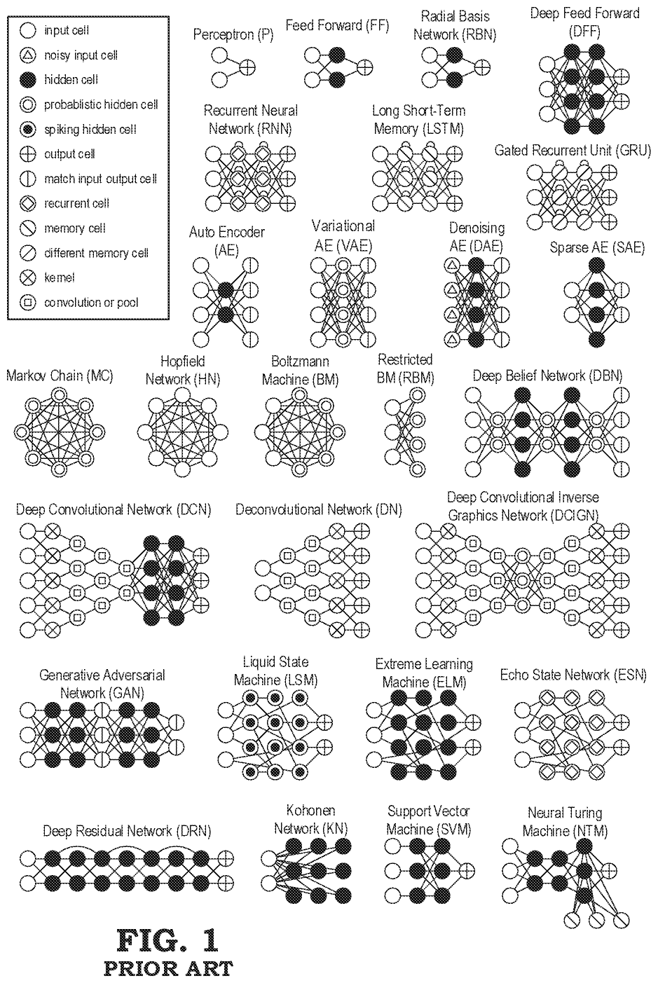

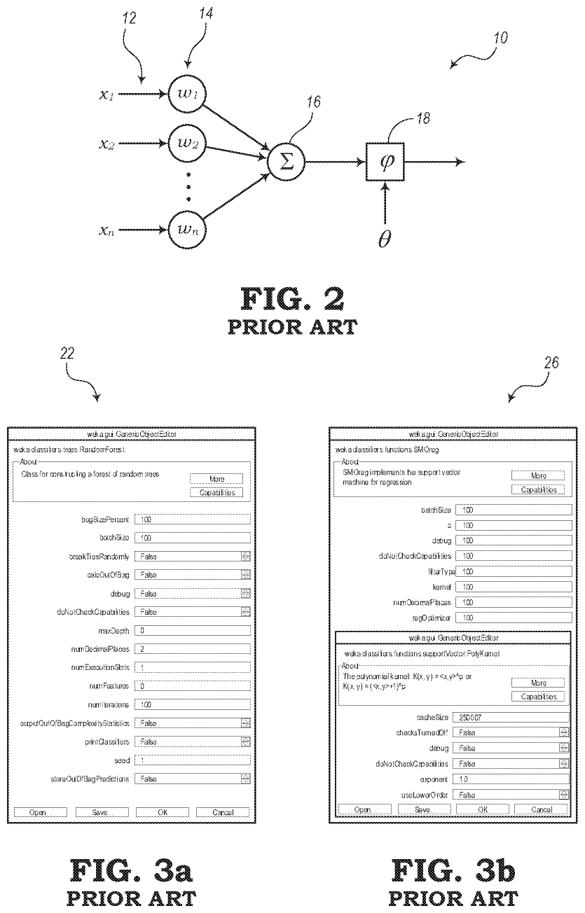

### DETAILED DESCRIPTION

The present disclosure relates to Artificial Intelligence (AI) and specifically relates to Machine Learning (ML) systems, methods, and techniques. The ML techniques of the present disclosure may be configured as adaptive techniques that learn how to perform various functions for creating a ML model in a meta-learning manner. That is, the ML techniques may use a meta-learning method for automatic machine learning to learn how to tune hyperparameters of ML techniques. As described in the present disclosure, the action of “tuning” hyperparameters may include adjusting the hyperparameters so as to strengthen, augment, or enhance the hyperparameters. A goal for example is to tune the hyperparameters so to as approach optimized values or to improve upon previous values by using the reward function. By learning to tune or strengthen these hyperparameters, the systems and methods of the present disclosure are able to significantly reduce the training time compared with conventional systems, minimize amount of data for training, maximize knowledge retention during transfer learning, etc. A system according to the present disclosure may apply an automatic ML process to learn how to learn tuning or enhancing skills. Also, the system can automatically tune hyperparameters of the ML techniques to build new ML models.

The adaptive ML systems may operate within the structure of a Reinforcement Learning (RL) system. For example, by defining “states,” “actions,” and “rewards” (e.g., as established within an RL system), the systems and methods of the present disclosure may be configured to tune hyperparameters to quickly and effectively train a ML model. Various metrics measured during intermediate ML model building steps can be used at a later time (i.e., as rewards in the RL system) to help the system to learn how to effectively tune hyperparameters.

Machine-learning techniques have significantly improved over the years to the point where properly trained ML models can now beat human experts at some specific but complex tasks. According to conventional methodology for training a new ML model, many parameters of the process (known as “hyperparameters”) are statically determined by a human expert before the model is trained. These hyperparameters are typically specific to the type of model or technique being used. The selection of hyperparameters can dramatically impact the training in many ways. For example, the way that hyperparameters are selected can impact the computational requirements of the ML techniques and can impact the training time. Furthermore, the hyperparameter selection may impact convergence, sample efficiency, and the overall accuracy of the model. For instance, given different hyperparameters, the same technique may quickly converge to an accurate model during training, may slowly converge to an inaccurate model (which would thereby require more training data before the model can be used effectively), may be unable to converge at all (e.g., if the learning rate is too high), etc.

As mentioned above with respect to known techniques (particularly deep neural networks), it is difficult to optimize hyperparameters using conventional methods. Typically, a human expert empirically defines a set of hyperparameters, trains a model, and repeats the process until results are satisfactory (e.g., when the accuracy/precision/recall characteristics of the model are good enough). The systems and methods of the present disclosure instead using an automated process, within a RL-based system, to learn how to tune hyperparameters quickly and accurately.

There has thus been outlined, rather broadly, the features of the present disclosure in order that the detailed description may be better understood, and in order that the present contribution to the art may be better appreciated. There are additional features of the various embodiments that will be described herein. It is to be understood that the present disclosure is not limited to the details of construction and to the arrangements of the components set forth in the following description or illustrated in the drawings. Rather, the embodiments of the present disclosure may be capable of other implementations and configurations and may be practiced or carried out in various ways. Also, it is to be understood that the phraseology and terminology employed are for the purpose of description and should not be regarded as limiting.

As such, those skilled in the art will appreciate that the inventive conception, upon which this disclosure is based, may readily be utilized as a basis for the designing of other structures, methods, and systems for carrying out the several purposes described in the present disclosure. Those skilled in the art will understand that the embodiments may include various equivalent constructions insofar as they do not depart from the spirit and scope of the present invention. Additional aspects and advantages of the present disclosure will be apparent from the following detailed description of exemplary embodiments which are illustrated in the accompanying drawings.

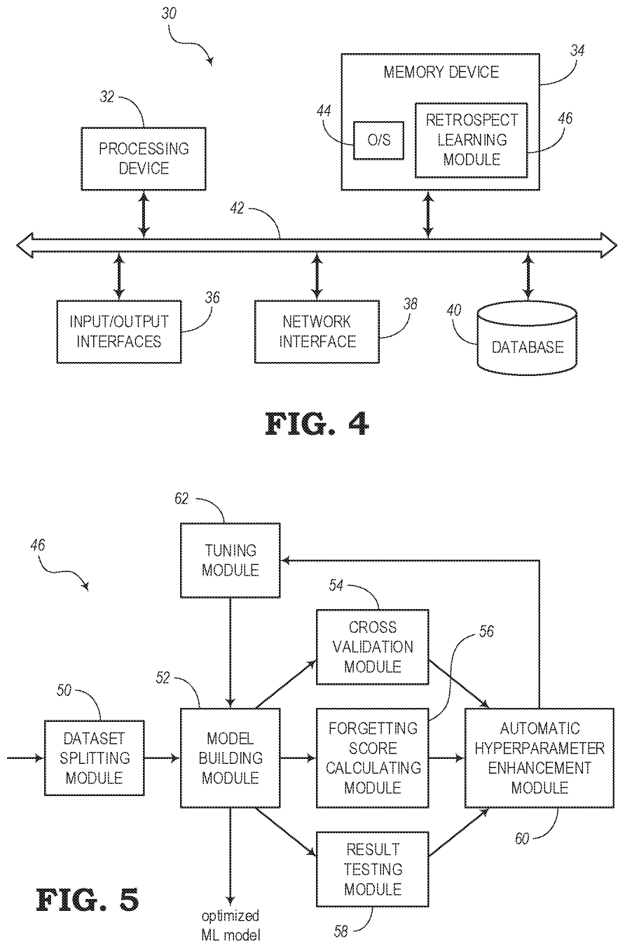

FIG. 4 is a block diagram illustrating an embodiment of an adaptive machine learning system 30. The adaptive machine learning system 30 includes a processing device 32, a memory device 34, input/output interfaces 36, a network interface 38, and a database 40. The devices 32, 34, 36, 38, 40 of the adaptive machine learning system 30 are interconnected with each other via a bus interface 42. The memory device 34 may be configured to store various software programs. For instance, the memory device 34 may include at least an operating system (O/S) 44 and a retrospect learning module 46. The retrospect learning module 46 may include logic instructions for causing the processing device 32 to perform adaptive ML functions to tune hyperparameters in a ML model according to the processes described in the present disclosure.

Those skilled in the pertinent art will appreciate that various embodiments may be described in terms of logical blocks, modules, circuits, algorithms, steps, and sequences of actions, which may be performed or otherwise controlled with a general purpose processor, a DSP, an application specific integrated circuit (ASIC), a field programmable gate array, programmable logic devices, discrete gates, transistor logic, discrete hardware components, elements associated with a computing device, or any suitable combination thereof designed to perform or otherwise control the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, those skilled in the pertinent art will appreciate that the various illustrative logical blocks, modules, circuits, algorithms, and steps described in connection with the embodiments described in the present disclosure may be implemented as electronic hardware, computer software, or any suitable combinations thereof. To clearly illustrate this interchangeability of hardware and software, various illustrative components, blocks, modules, circuits, algorithms, and steps have been described herein in terms of their general functionality. Whether such functionality is implemented in hardware or software depends upon the particular application and design constraints, and those skilled in the pertinent art may implement the described functionality in various ways to suit each particular application, but such implementation decisions should not be interpreted as causing a departure from the scope or spirit of the present disclosure. Additionally, the various logical blocks, modules, circuits, algorithms, steps, and sequences of actions described herein can be considered to be embodied entirely within any form of computer readable storage medium having stored therein a corresponding set of computer instructions that upon execution would cause an associated processor to perform the functionality described herein. Thus, the various aspects and embodiments disclosed herein may be embodied in a number of different forms, all of which have been contemplated to be within the scope or spirit of the claimed subject matter. In addition, for each of the embodiments described herein, the corresponding form of any such embodiments may be described herein as, for example, “logic configured to” perform the described action.

The methods, sequences and/or algorithms described in connection with the embodiments disclosed herein may be embodied directly in hardware, in a software module executed by a processor, or any suitable combination thereof. Software modules may reside in memory controllers, DDR memory, RAM, flash memory, ROM, electrically programmable ROM memory (EPROM), electrically erase programmable ROM (EEPROM), registers, hard disks, removable disks, CD-ROMs, or any other storage medium known in the art or storage medium that may be developed in the future. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal or other computing device. In the alternative, the processor and the storage medium may reside as discrete components in a user terminal or other computing device.

In one or more exemplary embodiments, the control functions described may be implemented in hardware, software, firmware, or any combination thereof. If implemented in software, the functions may be stored on or transmitted over as one or more instructions or code on a computer-readable medium. Computer-readable media includes both storage media and communication media, including any medium that facilitates transferring a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage, or other magnetic storage devices or media that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In the illustrated embodiment, the adaptive machine learning system 30 may be a digital computer that, in terms of hardware architecture, generally includes the processing device 32, the memory device 34, the input/output (I/O) interfaces 36, the network interface 38, and the database 40. The memory device 34 may include a data store, database (e.g., database 40), or the like. It should be appreciated by those of ordinary skill in the art that FIG. 4 depicts the adaptive machine learning system 30 in a simplified manner, where practical embodiments may include additional components and suitably configured processing logic to support known or conventional operating features that are not described in detail herein. The components (i.e., 32, 34, 36, 38, 40) are communicatively coupled via the local interface 42. The local interface 42 may be, for example, but not limited to, one or more buses or other wired or wireless connections. The local interface 42 may have additional elements, which are omitted for simplicity, such as controllers, buffers, caches, drivers, repeaters, receivers, among other elements, to enable communications. Further, the local interface 42 may include address, control, and/or data connections to enable appropriate communications among the components.

The processing device 32 is a hardware device adapted for at least executing software instructions. The processing device 32 may be any custom made or commercially available processor, a central processing unit (CPU), an auxiliary processor among several processors associated with the adaptive machine learning system 30, a semiconductor-based microprocessor (in the form of a microchip or chip set), or generally any device for executing software instructions. When the adaptive machine learning system 30 is in operation, the processing device 32 may be configured to execute software stored within the memory device 34, to communicate data to and from the memory device 34, and to generally control operations of the adaptive machine learning system 30 pursuant to the software instructions.

It will be appreciated that some embodiments of the processing device 32 described herein may include one or more generic or specialized processors (e.g., microprocessors, Central Processing Units (CPUs), Digital Signal Processors (DSPs), Network Processors (NPs), Network Processing Units (NPUs), Graphics Processing Units (GPUs), Field Programmable Gate Arrays (FPGAs), and the like). The processing device 32 may also include unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry” or “logic” that is “configured to” or “adapted to” perform a set of operations, steps, methods, processes, algorithms, functions, techniques, etc., on digital and/or analog signals as described herein for the various embodiments.

The I/O interfaces 36 may be used to receive user input from and/or for providing system output to one or more devices or components. User input may be provided via, for example, a keyboard, touchpad, a mouse, and/or other input receiving devices. The system output may be provided via a display device, monitor, graphical user interface (GUI), a printer, and/or other user output devices. I/O interfaces 36 may include, for example, a serial port, a parallel port, a small computer system interface (SCSI), a serial ATA (SATA), a fiber channel, InfiniBand, iSCSI, a PCI Express interface (PCI-x), an infrared (IR) interface, a radio frequency (RF) interface, and/or a universal serial bus (USB) interface.

The network interface 38 may be used to enable the adaptive machine learning system 30 to communicate over a network, such as a telecommunications network, the Internet, a wide area network (WAN), a local area network (LAN), and the like. The network interface 38 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n/ac). The network interface 38 may include address, control, and/or data connections to enable appropriate communications on the telecommunications network.

The memory device 34 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the memory device 34 may incorporate electronic, magnetic, optical, and/or other types of storage media. The memory device 34 may have a distributed architecture, where various components are situated remotely from one another, but can be accessed by the processing device 32. The software in memory device 34 may include one or more software programs, each of which may include an ordered listing of executable instructions for implementing logical functions. The software in the memory device 34 may also include a suitable operating system (O/S) and one or more computer programs. The operating system (O/S) essentially controls the execution of other computer programs, and provides scheduling, input-output control, file and data management, memory management, and communication control and related services. The computer programs may be configured to implement the various processes, algorithms, methods, techniques, etc. described herein.

The memory device 34 may include a data store (e.g., database 40) used to store data. In one example, the data store may be located internal to the adaptive machine learning system 30 and may include, for example, an internal hard drive connected to the local interface 42 in the adaptive machine learning system 30. Additionally, in another embodiment, the data store may be located external to the adaptive machine learning system 30 and may include, for example, an external hard drive connected to the I/O interfaces 36 (e.g., SCSI or USB connection). In a further embodiment, the data store may be connected to the adaptive machine learning system 30 through a network and may include, for example, a network attached file server.

Moreover, some embodiments may include a non-transitory computer-readable storage medium having computer readable code stored in the memory device 34 for programming the adaptive machine learning system 30 or other processor-equipped computer, server, appliance, device, circuit, etc., to perform functions as described herein. Examples of such non-transitory computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by the processing device 32 that, in response to such execution, cause the processing device 32 to perform a set of operations, steps, methods, processes, algorithms, functions, techniques, etc. as described herein for the various embodiments.

The adaptive machine learning system 30 of FIG. 4 is configured to perform meta-learning processes for teaching itself how to most efficiently and effectively train a ML model. In particular, meta-learning is used to learn how to tune hyperparameters of ML techniques for training the ML model. A goal of meta-learning is to use metadata to understand how automatic learning can become flexible in solving the issue of learning. The adaptive machine learning system 30 is able to improve the performance of existing ML techniques and learn (i.e., induce) the learning technique itself. The term meta-learning is sometimes referred to as the process of “learning to learn.”

In the tuning/optimizing processes of the adaptive machine learning system 30 of the present disclosure, many of the ML techniques are adaptive or have adaptive variants. The adaptive machine learning system 30 is configured to automatically adjust the hyperparameters of the ML techniques based on statistics obtained from the tuning processes used from one iteration to the next. The ability to adjust the hyperparameters effectively results in a higher rate of convergence. As opposed to other similar systems, the adaptive machine learning system 30 is configured to rely on a Reinforcement Learning (RL) scheme for optimizing the learning processes. In other words, the adaptive machine learning system 30 uses a reward system in a feedback loop to receive quantitative information about how well the optimization process is proceeding.

FIG. 5 is a block diagram illustrating an embodiment of the retrospect learning module 46 shown in FIG. 4. In this embodiment, the retrospect learning module 46 may include a number of sub-modules for performing the overall adaptive or retrospect processes. As the name implies, the term “retrospect” is used to describe the concept that previous information used during the learning process is not discarded, as is typically done in conventional system. Instead, the retrospect learning module 46 is configured to use this prior knowledge to some degree to learn how well certain tuning steps are able to actually improve or strengthen the hyperparameters.

Typically, Reinforcement Learning (RL) is used to learn the optimal policy to act on its environment given a reward function. That is, RL systems can learn the best mapping between states of the environment and actions that maximizes long term reward. Examples of RL applications include self-driving cars, games (e.g., chess, AlphaGo, etc.), and adaptive telecommunication networks.

The retrospect learning module 46 leverages RL in an unconventional manner. Instead of using RL to learn the best policy, the retrospect learning module 46 leverages RL to learn how to learn the best policy (also known as meta-learning). More particularly, the retrospect learning module 46 is configured to learn how to tune the hyperparameters of the ML technique.

The retrospect learning module 46 of the adaptive machine learning system 30 is fed with various data. In a telecommunications environment, the data obtained from a telecommunications network may include data from a Performance Management (PM) system, data from different customers, labels (e.g., tickets from Netcool), alarms from a Network Monitoring System (NMS), etc. Furthermore, the data used by the retrospect learning module 46 includes information from previous trained models. The previously obtained training information may include standard measurements for accuracy, precision and recall, as well as training times and inference times.

In addition, the retrospect learning module introduces a metric referred to herein as a “forgetting score.” The forgetting score is a metric that may be useful for evaluating how well a model can learn new patterns while retaining knowledge of previously learned patterns. The forgetting score can be calculated as follows: Using data_A, a model_A can be trained for a particular classification task (e.g., to detect loosely connected fibers). This results in a measurable metric of accuracy (accuracy_A). Then, model_A is fine-tuned using transfer learning techniques. That is, by using another dataset data_B, another model_AB can be trained with an accuracy of accuracy AB (data_B). In the case of a catastrophic forgetting, where no information is used from previous trials, a good accuracy_A (data_A) and accuracy AB (data_B) can be obtained, but the accuracy of the tuned model (model_AB) using old data (data_A) may results in a poor accuracy AB (data_A).

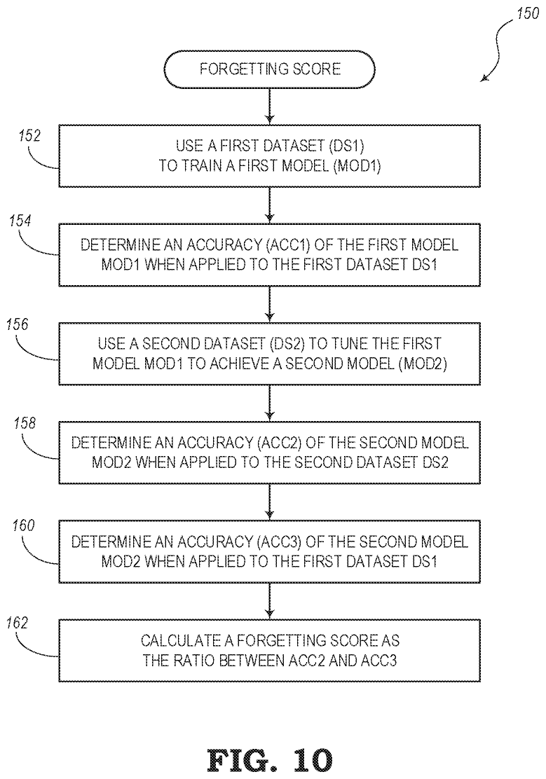

The forgetting score is calculated as the ratio of accuracy AB (data_B) and accuracy AB (data_A) in the above example. However, because of the low accuracy of accuracy AB (data_A), this example would lead to a high forgetting score. According to the present disclosure, it is desirable to obtain results that would provide a low forgetting score, which means that the previously learned patterns have been utilized effectively to better optimize the techniques. The calculation of forgetting score is further described below with respect to FIG. 10.

As shown in FIG. 5, the retrospect learning module 46 may include a dataset splitting module 50, a model building module 52, a cross validation module 54, a forgetting score calculating module 56, a result testing module 58, an automatic hyperparameter enhancement module 60, and a tuning module 62. According to some embodiments of the present disclosure, the input dataset from an environment may be split by the dataset splitting module 50 into two or more different datasets, whereby the different datasets can be used for performing different functions (e.g., training, validation, testing, etc.). The model building module 52 is configured to train a ML model from a portion of the input dataset and provide results to the modules 54, 56, 58.

The cross validation module 54 may be configured to utilize data in a validation dataset to perform validation testing, the results of which are provided to the automatic hyperparameter enhancement module 60. Also, forgetting score calculating module 56 may be configured to calculate a forgetting score, as defined herein. The resulting forgetting score can also be applied to the automatic hyperparameter enhancement module 60. Furthermore, the result testing module 58 may be configured to test the results of the model building process of the model building module 52 to determine accuracy. The result testing module 58 may also measure other metrics, such as precision, recall, training time, inference time, etc. These results are also provided to the automatic hyperparameter enhancement module 60.

The automatic hyperparameter enhancement module 60 is configured to receive input from the modules 54, 56, 58. From this information, the automatic hyperparameter enhancement module 60 is configured to automatically enhance or improve the hyperparameters in an effort to optimize or approach optimized hyperparameter values. The process of enhancing or improving the hyperparameters is based on the latest information, as well as previous information obtained during previous iterations of the ML model training process. The tuning module 62 may then be configured to fine-tune the model building module 52 based on the learned enhancement procedures to allow the model building module 52 to build a model that more closely approximates an ideal model. The feedback loop of the retrospect learning module 46 allows previous results to be utilized to fine-tune the model building process.

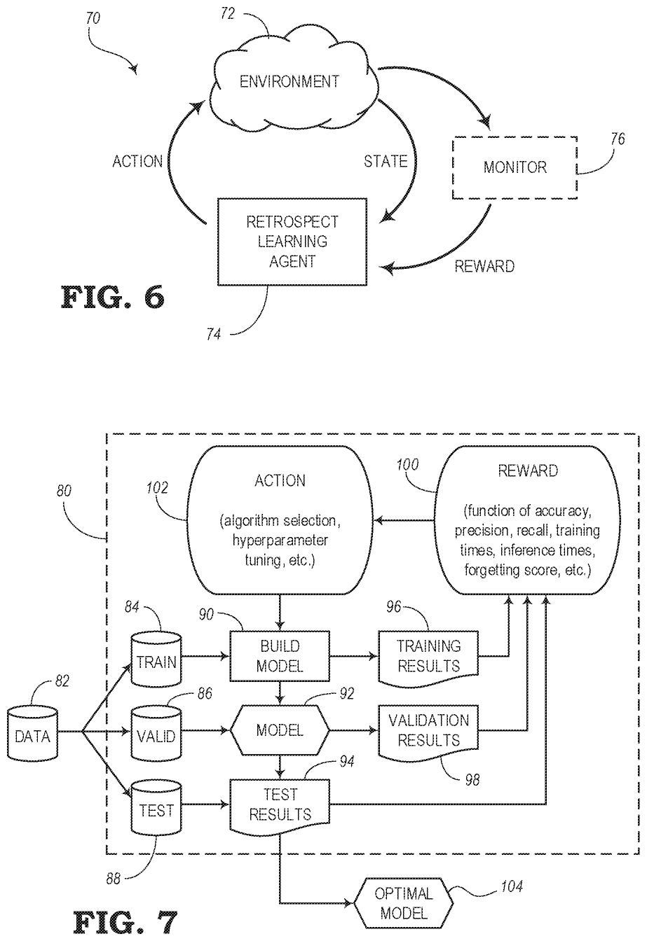

FIG. 6 is a block diagram illustrating a Reinforcement Learning (RL) system 70 in which the retrospect learning module of FIG. 4 may be utilized. In the RL system 70, an environment 72 (e.g., a telecommunications network, self-driving vehicle, etc.) operates according to its intended design. The state of the environment 72 is determined and provided to an agent within the RL system 70. In the present disclosure, the agent is configured as a retrospect learning agent 74, which may include the functionality of the retrospect learning module 46 and/or other parts of the adaptive machine learning system 30.

Based on the state of the environment 72, the retrospect learning agent 74 performs actions on the environment 72. Also, a monitor 76 is part of the RL system 70. The monitor 76 may be configured to gather information about the environment 72, such as the state information. The monitor 76 may then provide reward information to the retrospect learning agent 74. In this way, the retrospect learning agent 74 receives reward information that is used to influence how the actions are applied to the environment 72.

As opposed to supervised learning or unsupervised learning, which may be based on large amounts of unified and stationary datasets, the RL system 70 focuses on how the retrospect learning agent 74 should continuously interact with the environment 72 to maximize its reward. Although a conventional RL system may normally use massive trials used before or during the learning process, success of the RL system 70 may depend on manually crafted learning architectures and targets. However, the embodiments of the present disclosure use the fine-tuning processes for better optimizing how the hyperparameters of the ML techniques can be tuned.

The RL-based system 70 is configured to enhance or optimize the hyperparameter tuning process of models. In one example, the models may be used to predict issues in a telecommunications network. In this sense, the “state” of the RL system 70 may be configured by: a) performance metrics for each port (e.g., latency, dropped packets, etc.) from different customers and/or networks; b) performance metrics for each model (e.g., accuracy, precision, recall, computation time, manual corrections, etc.); c) parameters of previous trained ML models; d) labels/annotations from a human expert or Network Operations Center (NOC); e) alarms/tickets from a Network Monitoring System (NMS) or network operations software (e.g., Netcool); and/or f) statistics about historical changes.

The “actions” of the RL-based system 70 may include the action of fine-tuning the hyperparameters in the real number space (i.e., [symbol] ). According to the embodiments of the present disclosure, instead of being limited to a dozen or so possible values for each of the hyperparameter, there is no need with the present embodiments to discretize the hyperparameter space. In other words, tuning by the present embodiments may include utilizing any improvement or strengthening of the values to achieve the best possible results, which can be fine-tuned based on a computation or evaluation of the “rewards” in the RL-based system 70.

The “rewards” of the RL-based system 70 may rely on: a) maximizing the accuracy, precision, and/or recall; b) minimizing the amount of data required for training; c) minimizing computation time; d) minimizing human labeling; e) minimizing a cost associated with large hyperparameter changes; f) maximizing a transfer efficiency by using information learned for a previous model in future model building trials; and g) minimizing the forgetting score. Also, the rewards may be based on some weighted combination of the above metrics. The weights may be tuned by the operators depending on certain requirements and environments so as to maximize the reward.

Optimal model training using the RL-based system 70 may include minimizing the computation time of model training, thereby allowing active/continuous training to exist. The RL-base system 70 also improves sample efficiency and reduces amount of data required, thereby accelerating deployments of ML models in production. The system 70 can also minimize catastrophic forgetting issues commonly encountered with transfer learning schemes by utilizing a retrospective approach to process previously obtained results during intermediate iterations. The RL-based system 70 can efficiently and automatically tune hyper-parameters of models to predict network issues and train those models without human input or technical expertise about underlying ML models.

FIG. 7 is a diagram of a retrospect system 80 illustrating state, action, and reward components of the RL system 70 when applied to the adaptive machine learning system 30 of FIG. 4. The retrospect system 80 receives data from a data store 82, which may be the same as or similar to the database 40 shown in FIG. 4. In some embodiments, the data store 82 may store historical data, Performance Monitoring (PM) data, labels, etc. from multiple networks and customers in a telecommunications network. The data from the data store 82 may represent part of the “state” of the environment (e.g., networks). The data from the data store 82 may be split into multiple datasets. For example, a first random portion of the data from the data store 82 may be provided as a training dataset of a training data store 84, a second random portion of the data from the data store 82 may be provided as a validation dataset of a validation data store 86, and a third random (or remaining) portion of the data from the data store 82 may be provided as a testing dataset of a testing data store 88.

The retrospect system 80 includes a block 90 for building a model from the data in the training dataset of the training data store 84. The validation dataset of the validation data store 86 may then be applied to a model 92 that is built in the model building block 90 for obtaining validation results 98. Data from the testing data store 88 is applied to test results, which are created from the validation process. Training results 96 from the model built in block 90, along with the validation results 98 and test results 94, are applied to a reward process 100. In a sense, the training results 96, validation results 98, and test results 94 may be considered as part of the “state” within the RL scheme. The reward process 100 is configured to calculate a reward as a function of the training, validation, and testing results. The reward computation may be a function of accuracy, precision, recall, training times, inference times, forgetting score, etc.

The reward process 100 is configured to provide a reward computation to an action process 102, which is configured to determine the proper action for fine-tuning the build model block 90. The action process 102 may include actions such as a selection of a ML technique, hyperparameter tuning, etc. The feedback (or reward and action components of the RL system) are used to improve or enhance the model building process by optimally tuning the hyperparameters of the ML techniques of the ML model. Thus, the retrospect system 80 creates a feedback loop that attempts to maximize the rewards. The validation path may include a cross validation component for repeating the tuning process a predetermined number of times.

For example, a 10-fold cross-validation is a technique that may be used in the present embodiments to evaluate a ML model. A random fraction of the original dataset of the data store 82 (e.g., about 70-80% of the data of the data store 82), or training dataset of the training data store 84, may be used to train the model. The rest of the data from the data store 82 may be used to evaluate the model, such as by measuring the accuracy/precision/recall. The functions of the retrospect system 80 are repeated a number of times (e.g., 10 times for 10-fold cross-validation) to reduce the variance of the accuracy. In the 10-fold cross-validation process, the system 80 repeats the model-building, testing, rewarding, and tuning processes ten times.

A final optimal model 104 is trained on the complete dataset. In a conventional system that using x-fold cross-validation, the training process information obtained for each of the ten intermediate models is not saved and is lost. However, the embodiments of the retrospect system 80 of the present disclosure are configured to save and utilize not only the accuracy information of each of the models, but also other metrics that are normally ignored. Using the methods of the retrospect system 80, not only can the intermediate accuracies be measured, but the choice of hyperparameters and their corresponding accuracies can be measured. Also, other metrics are measured and can be used to train and improve the RL system, which will lead to a better choice of hyperparameters at the next iteration.

The retrospect system 80 is therefore able to learn to tune the hyperparameters and does not require systematic (stepwise) search of the parameter space. As an analogy, the number of possible positions on a board of a board game (e.g., chess, Go, etc.) makes exhaustive searches impractical. The RL techniques of the retrospect system 80 may be used in these types of games to quickly evaluate the board and optimize the next move to maximize long-term global rewards, without requiring a complete search of the possible moves.

Similarly, the approach of the retrospect system 80 is to estimate the next value of the hyperparameters without requiring a complete search of the hyperparameter space. The RL-based method of the retrospect system 80 natively supports highly-dimensional and continuous hyperparameters and does not require prior discretization. The state and reward functions within RL may be used to compute the forgetting score, which addresses the catastrophic forgetting issue, as the system will learn to select hyperparameters that minimize this issue. The term “catastrophic forgetting” may be used with reference to transfer learning. After training a model Ma on dataset a, it may be possible to continue and refine the training of that model using dataset b to create model Mab (assuming both datasets are reasonably comparable). Catastrophic forgetting is a situation when the accuracies of Ma on dataset a and Mab on b are good, while the accuracy of Mab on dataset a is poor. In other words, the refined model, supposedly with superior accuracy, can be described as suffering from catastrophic forgetting if it “forgot” what it learnt from the first dataset when trained on the second dataset.

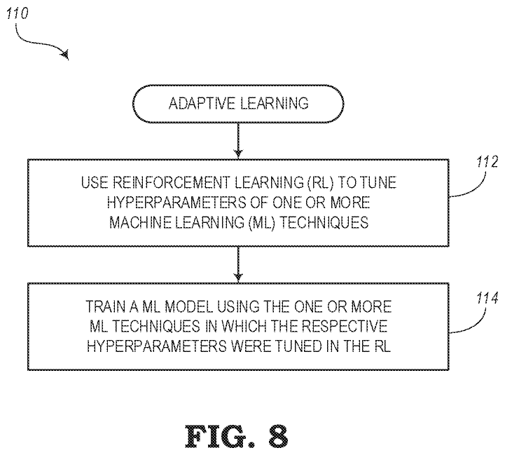

FIG. 8 is a flow diagram illustrating an embodiment of a generalized method 110 for training a ML model within the RL system. The method 110 includes the step of using RL to tune hyperparameters of one or more Machine Learning (ML) techniques, as indicated in block 112. The method 110 may also include the step of training a ML model using the one or more ML techniques in which the respective hyperparameters were tuned in the RL, as indicated in block 114.

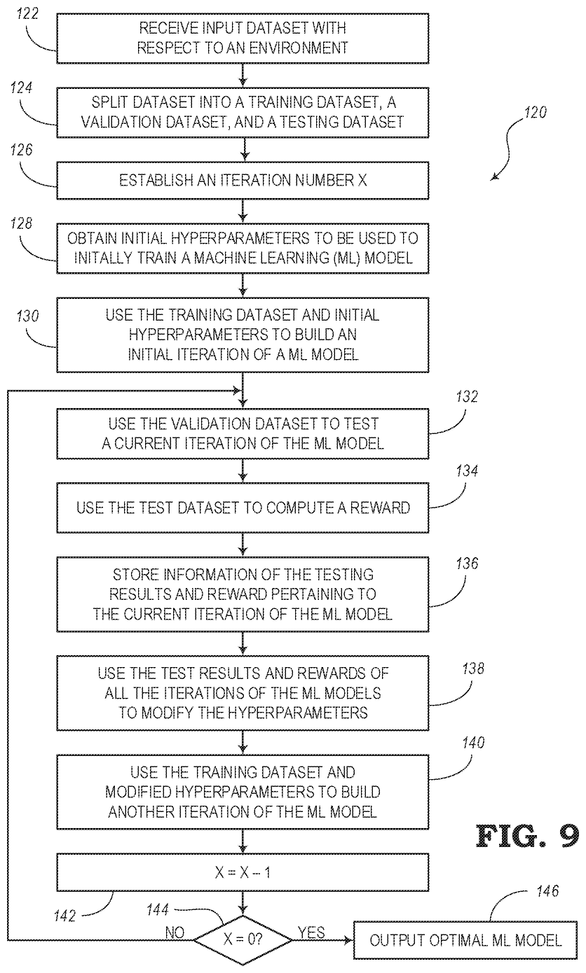

FIG. 9 is a flow diagram illustrating another method 120 for training a ML model, according to one embodiment. The method 120 includes a processing block 122, which describes the step of receiving an input dataset with respect to an environment for which a ML model is intended to be modeled. The method 120 further includes splitting the dataset into a training dataset, a validation dataset, and a testing dataset, as indicated in block 124. An iteration number “x” may be established for determining how many times iterations of ML models are trained before arriving at a final ML model. This value may also be referred to as the x-fold cross validation number.

The next step includes obtaining initial hyperparameters which are to be used to initially train a ML model, as indicated in block 128. The method 120 also includes using the training dataset and initial hyperparameters to build an initial iteration of a ML model, as indicated in block 130.

Thereafter, the method 120 includes using the validation dataset to test a current iteration of the ML model, as indicated in block 132. Then, the test dataset is used to compute a reward, as indicated in block 134. The reward may be based on a variety of metrics, including, for example, accuracy, precision, recall, training times, inference times, forgetting score, etc. The method 120 includes storing information about the testing results and reward pertaining to the current iteration of the ML model, as indicated in block 136. Then, the test results and rewards of all the iterations of the ML models are used to modify the hyperparameters, as indicated in block 138. The method 120 then includes using the training dataset and modified hyperparameters to build another iteration of the ML model, as indicated in block 140.

In block 142, the iteration number x is reduced by one. In decision diamond 144, it is determined whether or not the iteration number x is equal to zero. If so, designating that the method 120 has repeated the number of iterations as previously established, then the method 120 proceeds to block 146, which indicates that the optimal ML model has been trained and is output to an operator for implementing the ML model to perform the function for which it was designed. If it is determined in decision diamond 144 that the iteration number x does not equal zero, then the method 120 returns back to block 132 to repeat another model building iteration.

FIG. 10 is a flow diagram illustrating an embodiment of a method 150 for calculating a forgetting score. The forgetting score calculating method 150 includes the step of using a first dataset (DS1) to train a first model (MOD1), as indicated in block 152. Then, the method 150 includes determining an accuracy (ACC1) of the first model MOD1 when applied to the first dataset DS1, as indicated in block 154. Block 156 describes the step of using a second dataset (DS2) to tune the first model MOD1 to achieve a second model (MOD2). Block 158 describes the step of determining an accuracy (ACC2) of the second model MOD2 when applied to the second dataset DS2. Block 160 describes the step of determining an accuracy (ACC3) of the second model MOD2 when applied to the first dataset DS1. The method 150 further includes the step of calculating a forgetting score as the ratio between ACC2 and ACC3.

The systems and methods of the present disclosure provide a number of benefits with respect to conventional systems. First of all, the present embodiments provide a faster training time, since the tuning process is not confined to random or systematic searching, but can more quickly converge toward ideal hyperparameter value using a strategic (not random or systematic) approach utilizing reward feedback. Also, training with the present embodiments may require less data.

Another benefit is that the systems and methods of the present disclosure can provide better accuracy of the ML models because the training process saves and utilizes the metrics from previous iterations to help improve the tuning or optimization processes. Also, the system may be easier for customers to train and does not depend on expert tuning. A simplified learning curve for using the present systems enable customers or professional services with limited ML knowledge to train their own models with good accuracy.

As described above, the main problem that needs to be solved is hyperparameter tuning. ML is used to recognize patterns in data and then train a ML model. Each ML model has underlying techniques and each technique has a list of hyperparameters that can be chosen. In the training of conventional models, the hyperparameters are normally fixed. A first issue with ML is that the hyperparameters need to be defined by an expert. Second, there may be many hyperparameters to define. Currently, the best ML models are the ones with more hyperparameters.

The expert may use a trial and error approach to tune the hyperparameters in the conventional systems. First, the expert may try to define a first set of hyperparameters, and then train to get a first model. If this does not produce good results, the expert can then try again with a new set of hyperparameters, train to get another model, and so on. Training is thus very time consuming and each iteration may be very slow. It may take hours or even days to train a ML model. Also, it takes a lot of hard work on the part of the expert.

Currently, there are ML libraries that have emerged that try to automate this hyperparameter tuning process. In order to automate the process, the libraries may have different types of techniques to tune the hyperparameters. Some may use a random search process that randomly selects hyperparameters. Some may use an automatic search process, where you can essentially step through different values for a hyperparameter for one iteration, then repeat with a different value for the next iteration, etc. For example, the values for the hyperparameters may be discretized (e.g., whole numbers 1-10), where you try the value “1” first, then “2,” etc. The problem is when you have tens of possible values for each hyperparameter, the complexity of the training process grows exponentially. Therefore, it is not practical to use this type of approach when there is a large range of values that can be used for each hyperparameter.

In the present disclosure, a different type of training approach is used. Instead of learning by using the previously known fixed approaches for tuning the hyperparameters (e.g., random searching, automatic searching), the embodiments of the present disclosure use a type of learning technique referred to herein as “retrospect learning.” With retrospect learning, a technique is used that learns to interact with hyperparameters and can be used train complex patterns. In some cases, retrospect learning may be useful for complex learning and can be used to play chess or to learn other complex systems.

In some respects, the concept of retrospect learning may be similar to reinforcement learning in that retrospect learning finds a balance between “state” and “action” of the reinforcement paradigm. With retrospect learning, the techniques can look at the state of a system (or environment) and, from this state, the processes can take the best action. When used in a game environment, for instance, where game pieces are positioned at various squares on a game board, the action may be the movement of a piece at a certain time in the game.

The retrospect learning technique of the present disclosure applies a similar technique as reinforcement learning. The state of the environment may be defined as various parameters or results of a training model by an “agent” (e.g., a retrospect learning agent) in that the action includes tuning or optimizing the hyperparameters. Therefore, instead of using a systematic approach (e.g., random searching or automatic searching) to select a new value for a hyperparameter, the retrospect learning method is configured to learn how to adjust the hyperparameter. Thus, the retrospect learning process may change the hyperparameter from one value (e.g., 3) to another value (e.g., 4.2) based on previously learning patterns. This fine-tuning of the hyperparameter values is not normally done with other systems, especially since these other systems are normally confined to discretized values (e.g., whole numbers).

Also, this fine-tuning can be accomplished without the need for human intervention. Therefore, the retrospective learning process of the present embodiments does not rely on an expert to adjust the hyperparameters for each iteration of the trials for developing a ML model. In a sense, adjusting of hyperparameters can use a meta-learning technique for learning how to change hyperparameters in an effective manner to optimize the rewards under the reinforcement learning scheme. The retrospect learning process allows the ML system to learn to tune these hyperparameters over time, using previous results without forgetting what has been learned during the iterative process.

In some cases, if training is performed over time with different customers or different datasets over time, not only is the accuracy measured for the next training iteration, but also the accuracy and other metrics are gathered for use in order to allow the retrospect learning system to learn how to utilize the metrics in a way that tunes the hyperparameters and results in the greatest reward, based on whatever environment the ML model is run.

The reward function of the reinforcement scheme can be an important aspect in the retrospect learning process. The retrospect learning system (i.e., agent) may use various metrics and weight these metrics in such a way in order to learn how to find the reward, which may another key aspect of retrospect learning. For example, in the game of chess, a “reward” system may be used to give value to various pieces. That is, if a player takes an opponent's pawn, he/she may receive one point; if the player takes the opponent's queen, he/she may receive nine points. In other environments (e.g., a telecommunications network), other reward values can be established. Such a reward system can be established for determining how the retrospect learning system evaluates the various testing metrics when an iteration of an intermediate version of the ML model is trained.

The retrospect learning system of the present disclosure uses a meta-learning process to learn how to tune hyperparameters, which are then used for creating a ML model. One way to measure how well the system is at learning how to tune the hyperparameters, according to the embodiments of the present disclosure, is to measure how accurate the system is at arriving a different metrics. In addition to accuracy, other rewards may be provided for meeting other criteria. For example, the system can learn how fast it can perform the entire training process (i.e., training time) or can learn how fast the ML model can operate on new data (i.e., inference time). Other metrics can be used to evaluate how well the system performs with respect to any number of measurable parameters (e.g., accuracy, precision, recall, amount of data required to train, computation time, human interaction time, cost, transfer efficiency, etc.). Looking at the various rewards for the various metrics, the retrospect learning system can then work toward optimizing each one of the metrics, depending on the importance of each metric within the specific environment.

With retrospect learning, the retrospect learning system is able to learn the best hyperparameters of the ML model. Once the best hyperparameters (or the best combination of hyperparameters) are determined, the system is able to provide the best accuracy. Then the retrospect learning system can be used to train the ML model.

Although retrospect learning as describe in the present disclosure may have some similarities to reinforcement learning using the state, action, and reward scheme, the present retrospect learning embodiments do not necessarily rely on an expert using a brute force method or a random or automatic selection method, but instead the retrospect learning systems utilize the state, action, and reward processes in a non-constricting manner. Instead of being constrained by discrete values that may normally be provided by an expert, the retrospect learning methods utilize a technique to learn how to determine the optimum values for the hyperparameters.

Optimizing hyperparameters is currently a difficult problem in the field of machine learning. However, by using the retrospect learning systems and methods described in the present disclosure, a reinforcement approach can be used in a way to determine optimum values for the hyperparameters.

Previous solutions can either use a randomized approach or a more systematic approach. The systematic approaches may be too time-consuming and/or may be extremely complex. Also, these previous solutions may only be feasible if they are used with neural networks that have a small number of hyperparameters. However, the best neural network models are typically the ones that utilize multiple hidden layers and hence a large number of hyperparameters. Current solutions can usually only work well with up to about ten hyperparameters. After about 15-20 hyperparameters, it becomes impractical to use an automatic system for determining hyperparameters. Nevertheless, the retrospect learning systems and methods of the present disclosure are able to learn how to tune hyperparameters in way that analyzes a number of various metrics and can therefore perform the training process in a reasonable amount of time to arrive at an accurate model.

The retrospect learning systems of the present disclosure defines the state, action, and reward aspects of the reinforcement learning paradigm in a way that is different from other systems. The retrospect learning is configured to learn how to reduce training time. As an example, retrospect learning may learn patterns from customer A and then use these patterns for customer B. A basic model may be used for customer A. Then, the system performing additional learning for customer B with the goal of improving the training time for customer B. However, the system should not simply forget what it learned from customer A. A problem with many existing systems is that they forget. Thus, the present disclosure further defines a new metric, referred to herein as a “forgetting score,” which the retrospect learning system attempts to minimize. The forgetting score is used to evaluate how well a model can learn new patterns, while retaining knowledge of previously learned patterns.

Another benefit of the retrospect learning systems of the present disclosure is that the present system does not need to discretize the hyperparameter space. In other words, the hyperparameters may be set by the retrospect learning system using any value using any number of significant digits. Typically, when a “grid” search is used in previous solution, an expert might inject hyperparameters within a range (e.g., from 1 to 10). First, the expert may try 1, then 2, then 3, etc. However, the retrospect learning system recognizes during a previous learning process that occasionally it may be beneficial to use a value of 1.5 or 1.6, although this value is not part of the regular

The approach of the present embodiments is to select the ML technique. Not only can the ML technique be selected, but also the embodiments of the present disclosure can learn and/or predict which hyperparameters are best given a reward function.

Therefore, the present disclosure provides systems and methods for building ML models using meta-learning methods. One method of the present disclosure may include using a Reinforcement Learning (RL) system to learn how to tune hyperparameters of a plurality of Machine Learning (ML) techniques. This method may further include training a ML model using the plurality of ML techniques in which the respective hyperparameters are tuned.

This method may further be defined whereby the step of using the RL-based system may include the steps of storing information from one or more previous iterations of ML model-building processes and utilizing the stored information as a reward within the RL-based system. The stored information may include metrics of one or more intermediate ML models obtained during the one or more previous iterations. The metrics may include one or more of accuracy, precision, recall, training time, inference time, and forgetting score. The forgetting score may be used to evaluate how well the ML model-building processes can learn new patterns while retaining knowledge of previously learned patterns. The forgetting score may be calculated by: using a first dataset (DS1) to train a first model (MOD1); determining an accuracy (ACC1) of MOD1 when applied to DS1; using a second dataset (DS2) to tune MOD1 to achieve a second model (MOD2); determining an accuracy (ACC2) of MOD2 when applied to DS2; determining an accuracy (ACC3) of MOD2 when applied to DS1; and calculating a ratio between ACC2 and ACC3.

The method may further comprise the steps of receiving an input dataset with respect to an environment to be modeled, splitting the input dataset into at least a training dataset and a testing dataset, using the training dataset to build an intermediate ML model, and using the testing dataset to obtain metrics about the intermediate ML model. The step of the splitting the input dataset may further include the step of the splitting the input dataset into the training dataset, the testing dataset, and a validation dataset. The method may further comprise the step of utilizing the validation dataset to perform cross-validation multiple times to evaluate the intermediate ML model during multiple iterations. The RL-based system may include states defined as one or more of performance metrics, parameters of previously-training ML models, information provided by a human expert, information provided by an environment in which the ML model is intended to operate, and statistics about historical changes. The RL-based system may further include actions defined as a tuning of the hyperparameters. Also, the RL-based system may include rewards defined as one or more of maximizing accuracy, precision, and recall; minimizing amount of data required; minimizing computation time; minimize human labelling; minimizing cost associated with large hyperparameter changes; maximizing transfer efficiency; minimizing forgetting score; and a configurable weighted combination of these rewards.

Although the present disclosure has been illustrated and described herein with reference to exemplary embodiments providing various advantages, it will be readily apparent to those of ordinary skill in the art that other embodiments may perform similar functions, achieve like results, and/or provide other advantages. Modifications, additions, or omissions may be made to the systems, apparatuses, and methods described herein without departing from the spirit and scope of the present disclosure. All equivalent or alternative embodiments that fall within the spirit and scope of the present disclosure are contemplated thereby and are intended to be covered by the following claims.

What is claimed is:

1. A Machine Learning (ML) system comprising:
a processing device; and
a memory device configured to store a retrospect learning module having logic instructions configured to cause the processing device to
use Reinforcement Learning (RL) to tune hyperparameters of one or more ML techniques, and
train a ML model using the one or more ML techniques in which the respective hyperparameters were tuned with the RL.

2. The ML system of claim 1, wherein the logic instructions further cause the processing device to
store information from one or more previous iterations of ML model-building processes, and
utilizing the stored information as a reward within the RL.

3. The ML system of claim 2, wherein the stored information includes metrics of one or more intermediate ML models obtained during the one or more previous iterations, wherein the metrics include one or more of accuracy, precision, recall, a training time, an inference time, and a forgetting score, and wherein the forgetting score is used to evaluate how well the ML model-building processes can learn new patterns while retaining knowledge of previously learned patterns.

4. The ML system of claim 3, wherein the logic instructions further cause the processing device to calculate the forgetting score by
using a first dataset to train a first model,
determining a first accuracy of the first model when applied to the first dataset,
using a second dataset to tune the first model to achieve a second model,
determining a second accuracy of the second model when applied to the second dataset,
determining a third accuracy of the second model when applied to the first dataset, and
calculating a ratio between the second accuracy and the third accuracy.

5. The ML system of claim 1, wherein the logic instructions further cause the processing device to
receive an input dataset with respect to an environment for which the ML model is to be modeled,
split the input dataset into at least a training dataset and a testing dataset,
use the training dataset to build an intermediate ML model, and
use the testing dataset to obtain metrics about the intermediate ML model.

6. The ML system of claim 1, wherein the retrospect learning module comprises
a dataset splitting module configured to split an input dataset from an environment in which a ML model is intended to operate,
a model building module configured to build ML models in multiple iterations,
a result testing module configured to obtain metrics regarding each iteration,
an automatic hyperparameter enhancement module configured to automatically tune the hyperparameters of ML techniques of the ML model, and
a tuning module configured to tune the ML model based on the tuned hyperparameters.

7. The ML system of claim 6, wherein the retrospect learning module further comprises
a forgetting score calculating module for calculating a forgetting score used to evaluate how well the ML model can learn new patterns while retaining information about previously learned patterns.

8. A method comprising the steps of:
using Reinforcement Learning (RL) to tune hyperparameters of one or more Machine Learning (ML) techniques; and
training a ML model using the one or more ML techniques in which the respective hyperparameters were tuned with the RL.

9. The method of claim 8, wherein the step of using the RL-based system includes the steps of:
storing information from one or more previous iterations of ML model-building processes; and
utilizing the stored information as a reward within the RL-based system.

10. The method of claim 9, wherein the stored information includes metrics of one or more intermediate ML models obtained during the one or more previous iterations, and wherein the metrics include one or more of accuracy, precision, recall, training time, inference time, and forgetting score.

11. The method of claim 10, wherein the metrics include at least the forgetting score, and wherein the forgetting score is used to evaluate how well the ML model-building processes can learn new patterns while retaining knowledge of previously learned patterns.

12. The method of claim 11, further comprising the step of calculating the forgetting score by:
using a first dataset to train a first model;
determining a first accuracy of the first model when applied to the first dataset;
using a second dataset to tune the first model to achieve a second model;
determining a second accuracy of the second model when applied to the second dataset;
determining a third accuracy of the second model when applied to the first dataset; and
calculating a ratio between the second accuracy and the third accuracy.

13. The method of claim 8, further comprising the steps of:
receiving an input dataset with respect to an environment for which the ML model is to be modeled;
splitting the input dataset into at least a training dataset and a testing dataset;
using the training dataset to build an intermediate ML model; and
using the testing dataset to obtain metrics about the intermediate ML model.

14. The method of claim 13, wherein the step of the splitting the input dataset further includes the step of the splitting the input dataset into the training dataset, the testing dataset, and a validation dataset, wherein the method further comprises the step of utilizing the validation dataset to perform cross-validation multiple times to evaluate the intermediate ML model during multiple iterations.

15. The method of claim 8, wherein the RL-based system includes:
states defined as one or more of performance metrics, parameters of previously-training ML models, information provided by a human expert, information provided by an environment in which the ML model is intended to operate, and statistics about historical changes;
actions defined as a tuning of the hyperparameters; and
rewards defined as one or more of maximizing accuracy, precision, and recall; minimizing amount of data required; minimizing computation time; minimize human labelling; minimizing cost associated with large hyperparameter changes; maximizing transfer efficiency; minimizing forgetting score; and a configurable weighted combination of a plurality of these rewards.

16. A non-transitory computer-readable medium configured to store computer logic having instructions that, when executed, cause one or more processing devices to:
use Reinforcement Learning (RL) to tune hyperparameters of one or more Machine Learning (ML) techniques; and
train a ML model using the one or more ML techniques in which the respective hyperparameters were tuned with the RL.

17. The non-transitory computer-readable medium of claim 16, wherein the instructions further cause the one or more processing devices to
store information from one or more previous iterations of ML model-building processes, and
utilize the stored information as a reward within the RL-based system.

18. The non-transitory computer-readable medium of claim 17, wherein the stored information includes metrics of one or more intermediate ML models obtained during the one or more previous iterations, and wherein the metrics include one or more of accuracy, precision, recall, a training time, an inference time, and a forgetting score.

19. The non-transitory computer-readable medium of claim 18, wherein the instructions further cause the one or more processing devices to calculate the forgetting score to evaluate how well the ML model-building processes can learn new patterns while retaining knowledge of previously learned patterns.

20. The non-transitory computer-readable medium of claim 19, wherein the instructions further cause the one or more processing devices to calculate the forgetting score by using a first dataset to train a first model,
determining a first accuracy of the first model when applied to the first dataset,
using a second dataset to tune the first model to achieve a second model,
determining a second accuracy of the second model when applied to the second dataset,
determining a third accuracy of the second model when applied to the first dataset, and
calculating a ratio between the second accuracy and the third accuracy.
